(19) United States
(12) Patent Application Publication
(10) Pub. No.: US 2006/0085542 A1
(43) Pub. Date: Apr. 20, 2006

(54) System monitoring in multi-tier application environments

(76) Inventors: Jennifer Jie Fu, Cupertino, CA (US); Richard H. Van Gaasbeck, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/969,742

(22) Filed: Oct. 19, 2004

(51) Int. Cl. G06F 15/173

(52) U.S. Cl. 709/224

(57) ABSTRACT

A method of system monitoring in multi-tier application environments. In accordance with one embodiment of the present invention, a script is periodically initiated. System monitoring information is collected in accordance with the script. The system monitoring information is sent to a log file.

### TECHNICAL FIELD

Embodiments of the present invention relate to system monitoring in multi-tier application environments.

### BACKGROUND ART

The many and varied computing needs of an enterprise are increasingly being addressed by groups or clusters of computers and other data processing machines that are interconnected and managed to provide a seamless virtual computer image to a user. Such clusters are sometimes referred to as “utility” or “grid” computing, drawing an analogy to an electrical grid. Such clusters are also known as, or referred to as “multi-tier application environments.”

A layer of management software typically controls the operation of such clusters. For example, management software can partition complex tasks, assign tasks to various individual computers, balance workloads, enforce security, account for utilization, identify problems and generally monitor the operation of a cluster. Such management software is generally referred to as a system management application (SMA).

One of the generally many functions provided by system management applications is to monitor the “health” or status of the devices and processes of a computing cluster. For example, it is desirable to not only detect a hardware failure, e.g., of a networking adapter, but it is also desirable to identify the failing device and automatically initiate repair actions, e.g., to reset the device or schedule it for replacement. Similarly, system management applications generally monitor the status of programs and/or processes.

Thus a need exists for system monitoring in multi-tier application environments. A further need exists for system monitoring that is independent of system management applications. A still further need exists to meet the previously identified needs in a manner that is complimentary and compatible with conventional computer system control systems and processes.

### SUMMARY OF THE INVENTION

A method of system monitoring in multi-tier application environments is disclosed. In accordance with one embodiment of the present invention, a script is periodically initiated. System monitoring information is collected in accordance with the script. The system monitoring information is sent to a log file. Optionally, an application can be restarted if it is detected to be malfunctioning. An additional optional embodiment is to reset a hardware device that is detected to be malfunctioning. Another optional embodiment is to access the log file by a system management application.

### BRIEF DESCRIPTION OF THE DRAWINGS

FIG. 1 illustrates a utility data center that may form a platform for multi-tier applications, in accordance with embodiments of the present invention.

FIG. 2 illustrates another perspective of a utility data center that may form a platform for multi-tier applications, in accordance with embodiments of the present invention.

FIG. 3 is a flow chart illustrating a method of multi-layer system monitoring in a multi-tier application environment, in accordance with embodiments of the present invention.

### BEST MODES FOR CARRYING OUT THE INVENTION

In the following detailed description of the present invention, system monitoring in multi-tier application environments, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

### Notation and Nomenclature

Some portions of the detailed descriptions which follow (e.g., process 300) are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “storing” or “dividing” or “computing” or “testing” or “calculating” or “determining” or “storing” or “displaying” or “recognizing” or “generating” or “performing” or “comparing” or “synchronizing” or “accessing” or “retrieving” or “conveying” or “sending” or “resuming” or “installing” or “gathering” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### System Monitoring in Multi-Tier Application Environments

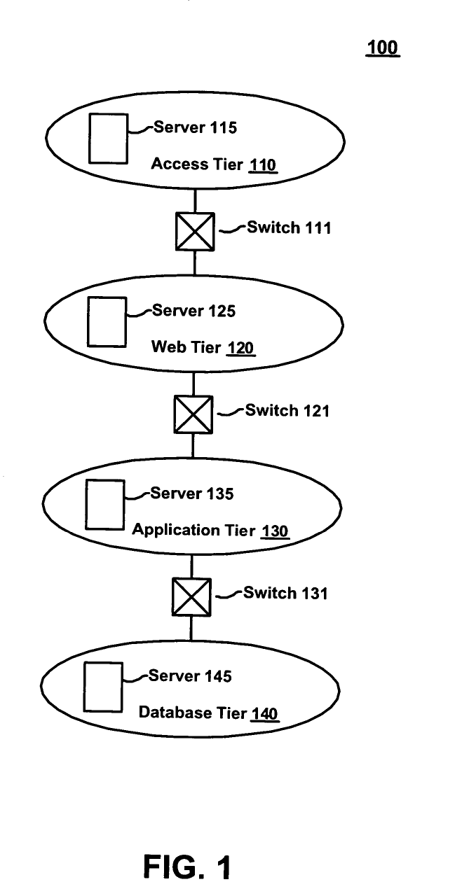

FIG. 1 illustrates a utility data center 100 that may form a platform for multi-tier applications, in accordance with embodiments of the present invention. Utility data center 100 comprises four tiers, an access tier 110, a web tier 120, an application tier 130 and a database tier 140.

The database tier 140 is generally populated with a variety of storage devices and architectures, including storage area networks (SAN). Streaming tape, different categories of redundant array of independent disks (RAID), various snapshot technologies and storage appliances can be used to populate database tier 140.

High speed switches, e.g., switch 131, link the database tier 140 to the application tier 130. This linking enables processing to be linked to data in a flexible, dynamic manner. Some application software can be installed at this layer, for example, enterprise resource planning (ERP) core systems. In general, most user applications, for example web servers, execute on the application tier 130.

Similarly, high speed switches, e.g., switch 121, link the application tier 130 to the web tier 120. Access to applications is managed uniformly with standard markup languages such as hypertext markup language (HTML) and extensible markup language (XML). Generally, network attached storage (NAS) appliances assist in the storage and caching of data for the application layer.

Web tier 120 comprises additional servers and storage to allow users to browse Web pages containing the information that they need. High speed switches, e.g., switch 111, link the web tier 120 with access tier 110. The access layer is where basic security functionality resides. For example, the data center side of virtual private networks (VPNs), authentication and authorization repositories and intrusion detection systems reside in the access tier 110.

While a utility data center offers great flexibility and efficiency, provisioning resources and executing an application within such a utility data center is highly complex. For example, an application appearing as a single session to a user generally involves different software operating on different server computer systems, e.g., servers 115, 125, 135 and 145, in the different tiers.

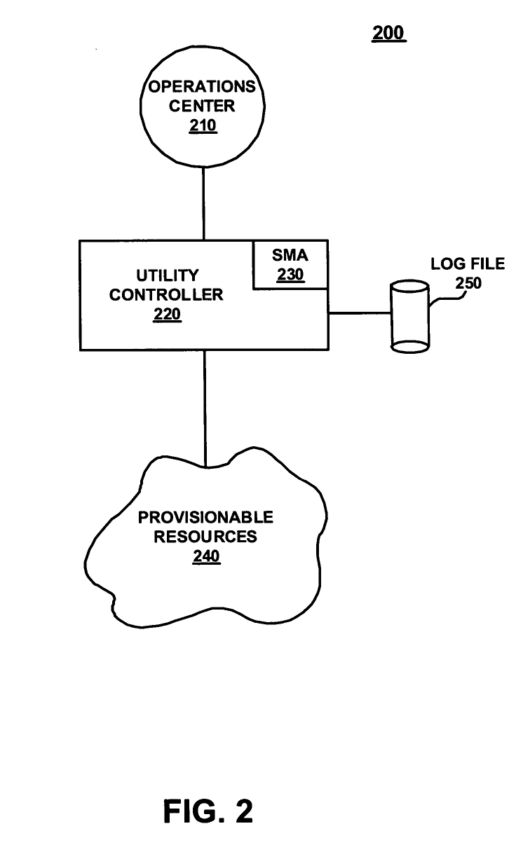

FIG. 2 illustrates another perspective of a utility data center 200 that may form a platform for multi-tier applications, in accordance with embodiments of the present invention. Utility data center 200 comprises an operations center 210. Operations center 210 provides integrated services management for utility data center 200. For example, operations center 210 can generally provide a service information portal, service delivery, service assurance, and service usage management for utility data center 200.

Utility data center 200 further comprises a utility controller 220. Utility controller 220 controls a set of provisionable resources 240. For example, utility controller 220 can generally control support services, backup storage arrays, servers, appliances, storage fabrics and/or IP network fabrics.

Provisionable resources 240 comprise a flexible variety of computing, communication and/or data storage resources that provide computing services for customers of utility data center 200. A system management application 230, if present, typically operates at utility controller 220.

There are a variety of products available to provide such system management software functions for computing clusters. Examples of system management applications (SMA) include the system management application commercially available under the trademark OPENVIEW OPERATIONS from Hewlett-Packard Company of Delaware and the system management application commercially available under the trademark TIVOLI® from International Business Machines Corporation of New York.

Unfortunately, such system management applications are highly complex, and require very expensive operating licenses. In addition, most conventional system management applications require highly trained operators to install, configure, operate and interpret results from such system management applications.

In many instances of a computing cluster, e.g., utility data center 200, a system management application is utilized to monitor and control the operation of a computing cluster. For example, a system management application can be used to provision a computing cluster.

System management applications have conventionally been used to perform system monitoring. However, for a variety of reasons, it is oftentimes desirable to perform system monitoring though other means. For example, for reasons of cost and/or complexity, a system management application may not be available. At other times, in can be desirable to conduct system monitoring in a manner that is independent of a particular system management application.

When a system management application is used for system monitoring, typically a very complex and direct relationship is created between applications and devices within the cluster and the system management application. This direct relationship can cause problems when hardware and software are added to and/or changed within the cluster. Further, such direct relationships make it very difficult to change from one system management application to another system management application.

In addition, a variety of situations can exist in which health monitoring is desirable, but other features of general-purpose system management applications are not desirable. For example, in some cases, the expense of a general-purpose system management application can be a deterrent to its use. In other cases, for example, the complexity of configuration and operation of a general-purpose system management application is undesirable.

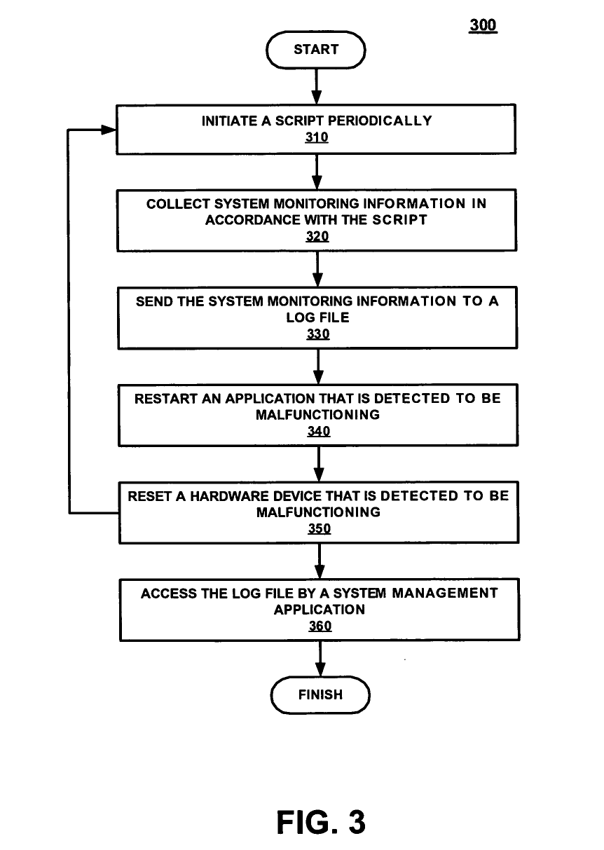

FIG. 3 is a flow chart illustrating a method 300 of multi-layer system monitoring in a multi-tier application environment, in accordance with embodiments of the present invention.

In block 310, a script, or sequence of commands, is initiated periodically. Embodiments in accordance with the present invention are well suited to a variety of periodicities, e.g., every minute, every hour, or at specific times, e.g., fifteen minutes past each hour.

In accordance with embodiments of the present invention, a “cron” command can be utilized to periodically initiate the script.

The “cron” command (sometimes also known as “crontab”) is generally a function provided in Unix-like operating systems. This command is utilized to schedule the execution of other commands or scripts (lists) of commands to be executed periodically and/or at particular times. It is appreciated that there are generally similar facilities available in other operating systems, for example as a native part of the operating system or as an add-on function.

In block 320, system monitoring information is collected in accordance with the script. In block 330, the system monitoring information is sent to a log file, e.g., log file 250 as depicted in FIG. 2.

Referring once again to FIG. 3, in optional block 340, an application that is detected to be malfunctioning is restarted. In optional block 350, a hardware device that is detected to be malfunctioning is reset.

In this novel manner, system monitoring can be performed independently of a system management application. However, in accordance with other embodiments of the present invention, a system management application can utilize system monitoring information from the log file, benefiting, for example, from enhanced display capabilities of a system management application. In this manner, a system can be monitored in a manner independent of a system management application. This enables, for example, a change from a first system management application to a second system management application without impacting a system monitoring installation.

In optional block 360, the log file is accessed by a system management application.

Embodiments in accordance with the present invention enable multiple layers of system monitoring. For example, a first layer of system monitoring can comprise monitoring only a few key processes, e.g., a local domain name server and/or a segment manager. In the case of a minimal layer of system “monitoring,” an instance of method 300 could periodically reset key applications to ensure that such applications are operating. In such a case, no actual information need be received or “monitored” from an application.

An exemplary second layer of system monitoring can comprise, for example, a second instance of method 300 comprising instructions to monitor a wider set of applications and/or hardware. It is to be appreciated that one layer of system monitoring can actually monitor another layer of system monitoring. For example, the exemplary first layer of system monitoring described above can monitor the exemplary second layer of system monitoring also described above.

Another possible layer of system monitoring comprises utilizing a system management application to access and/or act upon monitoring information provided in a log file. In such a case the system management application does not actually perform the interaction, e.g., polling and/or receiving exception signals, with various hardware and software to determine status, but rather accesses such information from a log file. In this novel manner, benefits of having system monitoring information available to a system management application can be realized without the complexity of configuring all monitored entities (hardware and/or software) to communicate with a specific system management application.

Embodiments of the present invention provide system monitoring in multi-tier application environments. Further embodiments of the present invention for system monitoring that is independent of system management applications. Still further embodiments of the present invention meet the previously identified need in a manner that is complimentary and compatible with conventional computer system control systems and processes.

Embodiments in accordance with the present invention, system monitoring in multi-tier application environments, are thus described. While the present invention has been described in particular embodiments, it should be appreciated that the present invention should not be construed as limited by such embodiments, but rather construed according to the below claims.

What is claimed is:

1. A method of multi-layer system monitoring in a multi-tier application environment comprising:
initiating a script periodically;
collecting system monitoring information in accordance with said script; and
sending said system monitoring information to a log file.

2. The method of claim 1 wherein said script is initiated by the “cron” facility of a Unix-like operating system.

3. The method of claim 2 further comprising accessing said log file by a system management application.

4. The method of claim 1 further comprising restarting an application that is detected to be malfunctioning.

5. The method of claim 1 further comprising resetting a hardware device that is detected to be malfunctioning.

6. A system of system monitoring comprising a log file wherein said log file is generated by a script launched by a command scheduler.

7. The system of claim 6 wherein said script is launched periodically.

8. The system of claim 6 wherein said command scheduler is a “cron” facility of a Unix-like operating system.

9. The system of claim 6 wherein said log file is accessible by a system management application.

10. The system of claim 6 that does not comprise a system management application.

11. A computer usable media comprising computer usable instructions, which when executed on a computer processor implement a method of multi-layer system monitoring in a multi-tier application environment, said method comprising:
initiating a script periodically,
collecting system monitoring information in accordance with said script; and
sending said system monitoring information to a log file.

12. The system of claim 11 wherein said script is initiated by the “cron” facility of a Unix-like operating system.

13. The system of claim 12 further comprising accessing said log file by a system management application.

14. The system of claim 12 further comprising restarting an application that is detected to be malfunctioning.

15. The system of claim 12 further comprising resetting a hardware device that is detected to be malfunctioning.

16. The system of claim 12 further comprising a log file wherein said log file is generated by said script.
